(19) United States
(12) Patent Application Publication
(10) Pub. No.: US 2024/0380470 A1
(43) Pub. Date: Nov. 14, 2024

(54) BEAM SWITCHING BASED ON USER EQUIPMENT BEAM REFINEMENT PROCEDURE

(71) Applicant: Qualcomm Incorporated, San Diego, CA (US)

(72) Inventors: Ruhua HE, San Diego, CA (US); Derrick Albert CHU, San Diego, CA (US); Raghu Narayan CHALLA, San Diego, CA (US)

(21) Appl. No.: 18/398,264

(22) Filed: Dec. 28, 2023

Related U.S. Application Data
(60) Provisional application No. 63/501,997, filed on May 12, 2023.

(51) Int. Cl. H04B 7/06; H04L 5/00; H04W 76/20

(52) U.S. Cl. CPC H04B 7/06958; H04B 7/0626; H04L 5/0051; H04W 76/20

(57) ABSTRACT

Various aspects of the present disclosure generally relate to wireless communication. In some aspects, a user equipment (UE) may receive, for a UE beam refinement procedure, a reference signal via a first network node beam. The UE may receive, based at least in part on the UE beam refinement procedure, an indication of a switch to the first network node beam from a second network node beam. Numerous other aspects are described.

### CROSS-REFERENCE TO RELATED APPLICATION

This Patent application claims priority to U.S. Provisional Patent Application No. 63/501,997, filed on May 12, 2023, entitled “BEAM SWITCHING BASED ON USER EQUIPMENT BEAM REFINEMENT PROCEDURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for beam switching based on a user equipment (UE) beam refinement procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may, individually or in any combination, be configured to receive, for a UE beam refinement procedure, a reference signal via a first network node beam. The one or more processors may, individually or in any combination, be configured to receive, based at least in part on the UE beam refinement procedure, an indication of a switch to the first network node beam from a second network node beam.

Some aspects described herein relate to a network node for wireless communication. The network node may include one or more memories and one or more processors coupled to the one or more memories. The one or more processors may, individually or in any combination, be configured to output, for a UE beam refinement procedure, a reference signal via a first network node beam. The one or more processors may, individually or in any combination, be configured to output, based at least in part on the UE beam refinement procedure, an indication of a switch to the first network node beam from a second network node beam.

Some aspects described herein relate to a method of wireless communication performed by a UE. The method may include receiving, for a UE beam refinement procedure, a reference signal via a first network node beam. The method may include receiving, based at least in part on the UE beam refinement procedure, an indication of a switch to the first network node beam from a second network node beam.

Some aspects described herein relate to a method of wireless communication performed by a network node. The method may include outputting, for a UE beam refinement procedure, a reference signal via a first network node beam. The method may include outputting, based at least in part on the UE beam refinement procedure, an indication of a switch to the first network node beam from a second network node beam.

Some aspects described herein relate to a non-transitory computer-readable medium that stores a set of instructions for wireless communication by a UE. The set of instructions, when executed by one or more processors of the UE, may cause the UE to receive, for a UE beam refinement procedure, a reference signal via a first network node beam. The set of instructions, when executed by one or more processors of the UE, may cause the UE to receive, based at least in part on the UE beam refinement procedure, an indication of a switch to the first network node beam from a second network node beam.

Some aspects described herein relate to a non-transitory computer-readable medium that stores a set of instructions for wireless communication by a network node. The set of instructions, when executed by one or more processors of the network node, may cause the network node to output, for a UE beam refinement procedure, a reference signal via a first network node beam. The set of instructions, when executed by one or more processors of the network node, may cause the network node to output, based at least in part on the UE beam refinement procedure, an indication of a switch to the first network node beam from a second network node beam.

Some aspects described herein relate to an apparatus for wireless communication. The apparatus may include means for receiving, for an apparatus beam refinement procedure, a reference signal via a first network node beam. The apparatus may include means for receiving, based at least in part on the apparatus beam refinement procedure, an indication of a switch to the first network node beam from a second network node beam.

Some aspects described herein relate to an apparatus for wireless communication. The apparatus may include means for outputting, for a UE beam refinement procedure, a reference signal via a first network node beam. The apparatus may include means for outputting, based at least in part on the UE beam refinement procedure, an indication of a switch to the first network node beam from a second network node beam.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information reference signal (CSI-RS) beam management procedures, in accordance with the present disclosure.

FIG. 5 is a diagram illustrating an example of a timeline of beam management operations, in accordance with the present disclosure.

FIG. 6 is a diagram illustrating an example associated with beam switching based on a UE beam refinement procedure, in accordance with the present disclosure.

FIG. 7 is a diagram illustrating an example of beam switching based on a UE beam refinement procedure, in accordance with the present disclosure.

FIG. 8 is a diagram illustrating an example of autonomous UE beam switching, in accordance with the present disclosure.

FIG. 9 is a diagram illustrating an example of channel state feedback (CSF) updating, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

A network node and a user equipment (UE) may select beams (e.g., a network node beam and a UE beam) using P1, P2, and/or P3 sessions. During a P1 session, a network node and a UE may establish an initial beam pair link (BPL) that includes a wide network node beam and a UE beam. During a P2 session, the network node may perform network node beam refinement by sweeping one or more narrow beams within the wide beam while transmitting a reference signal over the narrow beam(s). During a P3 session, the UE may perform UE beam refinement by sweeping one or more UE beams while receiving a reference signal over a narrow beam that was selected as a result of the P2 session. A P1, P2, and/or P3 session may occur at any suitable time (e.g., after initial P1, P2, and P3 sessions have occurred).

Based on a P2 session, a network node may determine that the network node is to switch from one network node beam (e.g., a narrow beam) to another network node beam. If the two network node beams are associated with different wide beams, then the network node outputs a media access control (MAC) control element (MAC-CE) indicating that the network node is switching narrow beams. Based on the MAC-CE, the UE may switch from the UE beam to a different UE beam. However, the UE beam to which the UE switches may be suboptimal because that UE beam may be associated with a wide beam based on a previous P1 session (e.g., rather than the narrow beam that the network node 110 is switching to). If the network node beams are associated with the same wide beam, then the network node may not output any MAC-CE indicating that the network node is switching narrow beams. As a result, the UE may continue using the same UE beam, even if that UE beam is suboptimal for the narrow beam that the network node 110 is switching to. Thus, regardless of whether the network node beams are associated with different wide beams or with the same wide beam, after the network node beam switch, the UE may use a UE beam that is suboptimal.

Various aspects relate generally to wireless communication, and more particularly to beam management. Some aspects more specifically relate to beam switching based on a UE beam refinement procedure. In some examples, a network node may output, and a UE may receive, for a P3 session, a reference signal via a first network node beam. For example, the first network node beam may be a first narrow beam. The reference signal may enable the UE to determine a quality of a BPL that includes the first network node beam. The network node may further output, and the UE may further receive, based at least in part on (e.g., after) the P3 session, a MAC-CE indicating that the network node is to switch to the first network node beam from a second network node beam. The second network node beam may be a second narrow beam (e.g., one of a plurality of narrow beams measured during a prior network node beam refinement procedure). The first and second network node beams may be associated with different wide beams or with the same wide beam.

Particular aspects of the subject matter described in this disclosure can be implemented to realize one or more of the following potential advantages. In some examples, by outputting or receiving the MAC-CE based at least in part on the P3 session, the described techniques can be used to switch to an appropriate UE beam (e.g., a UE beam that provides a high-quality BPL, such as a highest-quality BPL among the candidate UE beams measured during the P3 session). When the first and second network node beams are associated with different wide beams, the UE may identify the appropriate UE beam based on the P3 session before receiving the MAC-CE. When the first and second network node beams are associated with the same wide beam, the MAC-CE may prompt the UE to perform the UE beam switch to the appropriate UE beam.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

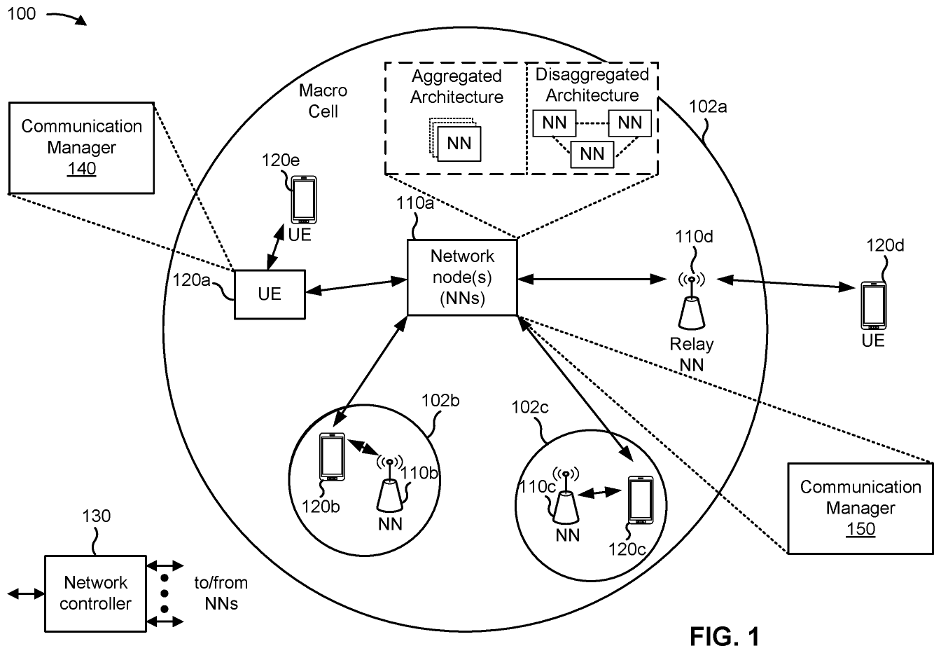

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, for a UE beam refinement procedure, a reference signal via a first network node beam; and receive, based at least in part on the UE beam refinement procedure, an indication of a switch to the first network node beam from a second network node beam. Additionally, or alternatively, the communication manager 140 may perform one or more other operations described herein.

In some aspects, the network node 110 may include a communication manager 150. As described in more detail elsewhere herein, the communication manager 150 may output, for a UE beam refinement procedure, a reference signal via a first network node beam; and output, based at least in part on the UE beam refinement procedure, an indication of a switch to the first network node beam from a second network node beam. Additionally, or alternatively, the communication manager 150 may perform one or more other operations described herein.

As indicated above, FIG. 1 is provided as an example. Other examples may differ from what is described with regard to FIG. 1.

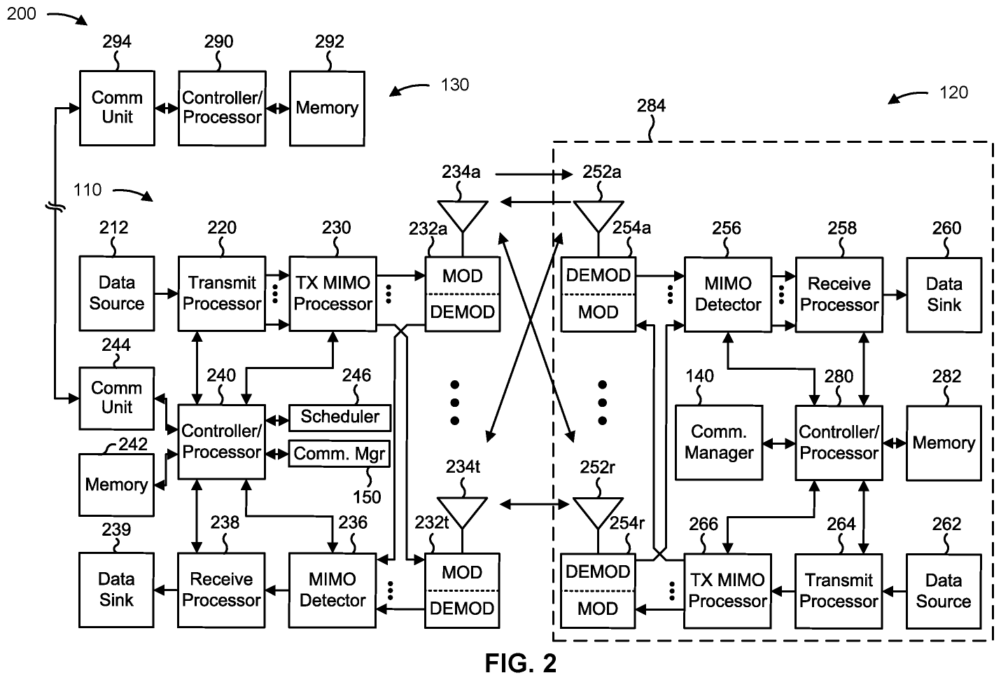

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

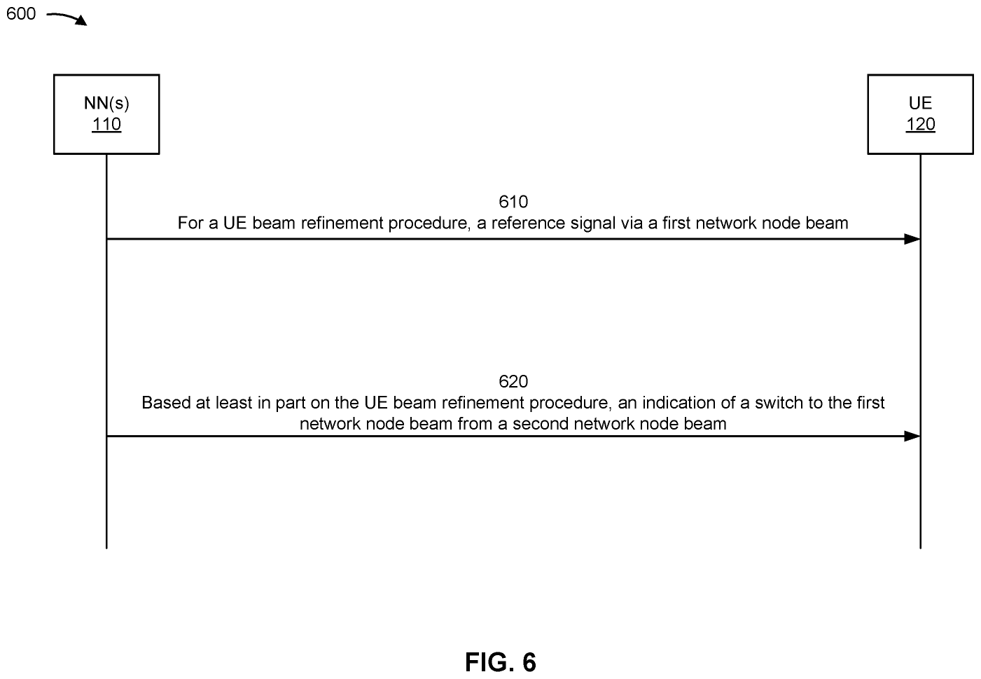

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

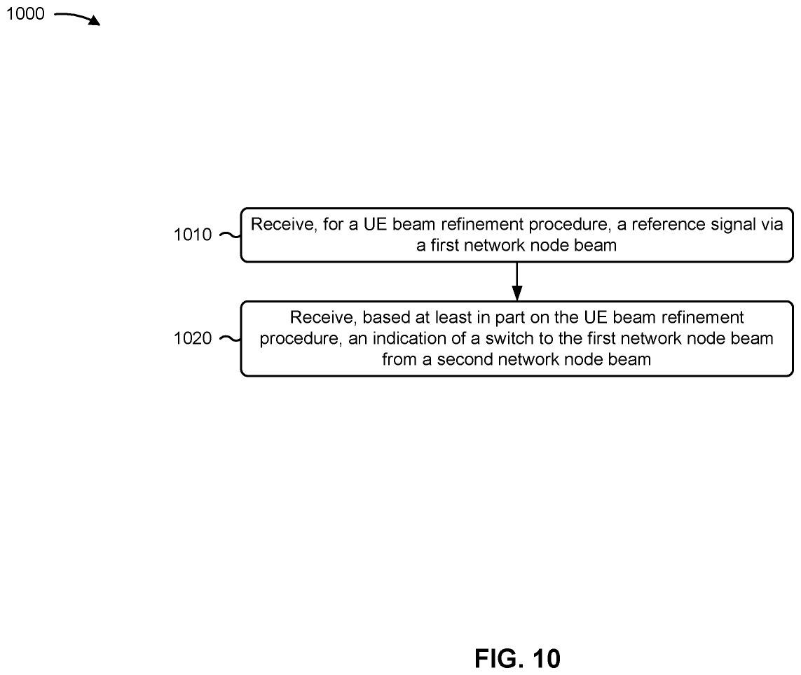

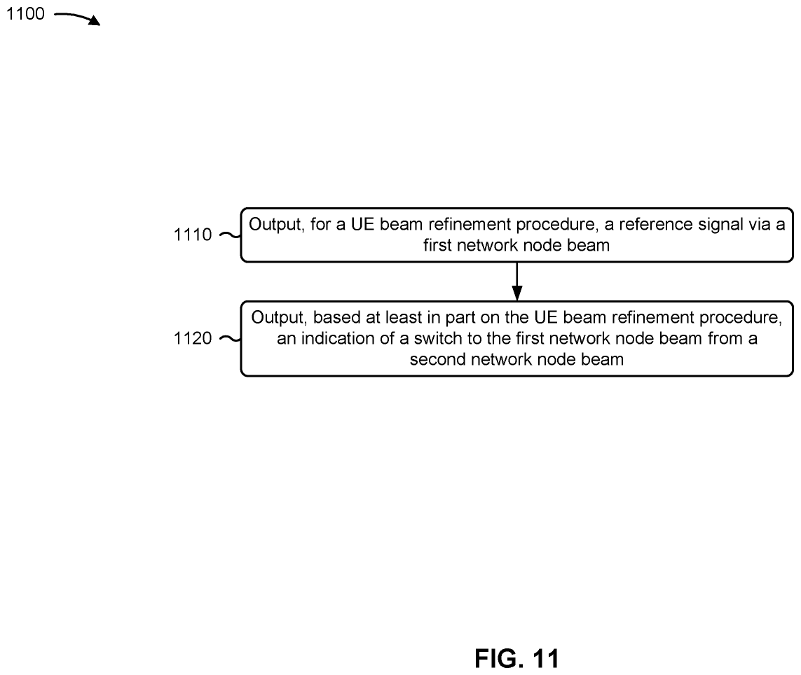

The controller/processor 240 of the network node 110, the controller/processor 280 of the UE 120, and/or any other component(s) of FIG. 2 may perform one or more techniques associated with beam switching based on a UE beam refinement procedure, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving, for a UE beam refinement procedure, a reference signal via a first network node beam (e.g., using antenna 252, modem 254, MIMO detector 256, receive processor 258, controller/processor 280, memory 282, or the like); and/or means for receiving, based at least in part on the UE beam refinement procedure, an indication of a switch to the first network node beam from a second network node beam (e.g., using antenna 252, modem 254, MIMO detector 256, receive processor 258, controller/processor 280, memory 282, or the like). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for outputting, for UE beam refinement procedure, a reference signal via a first network node beam (e.g., using controller/processor 240, transmit processor 220, TX MIMO processor 230, modem 232, antenna 234, memory 242, or the like); and/or means for outputting, based at least in part on the UE beam refinement procedure, an indication of a switch to the first network node beam from a second network node beam (e.g., using controller/processor 240, transmit processor 220, TX MIMO processor 230, modem 232, antenna 234, memory 242, or the like). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

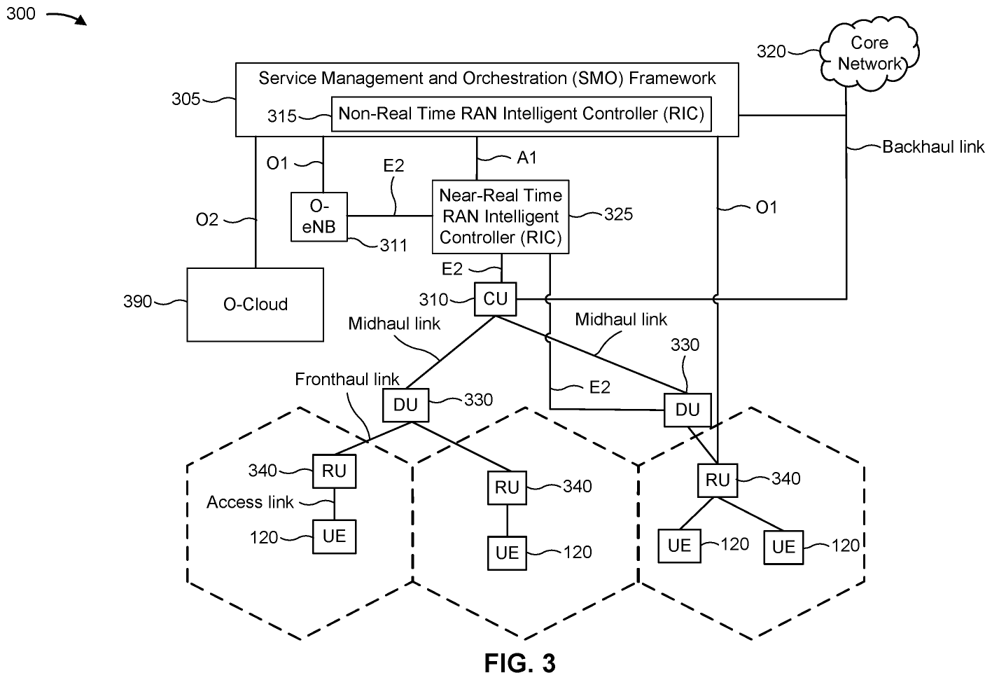

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Millimeter wave (mmWave) propagation differs from sub-6 GHZ propagation in several respects. For example, mmWave propagation can involve higher pathloss, different types of mobility introduced by UE translational and/or rotational motions, cluster jumps and blockers, or the like. Beam management may help to address these properties of mmWave propagation. For example, beamforming may be used to overcome large pathloss, to establish and maintain a BPL between a UE and a network node, for mobility management, or the like.

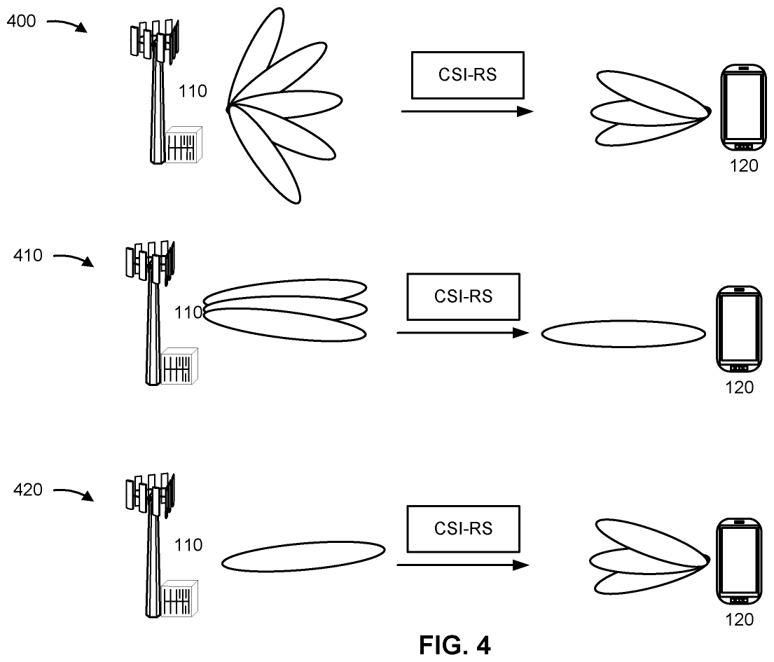

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

In example 400, P1 beam management may involve establishing an initial BPL between a UE and a network node using SSB-type beam management or CSI-RS-type beam management (CSI-RS [BM]). During P1 beam management, the network node may perform an SSB-based beam sweep, and the UE may sweep UE beams, based on a UE codebook, against all P1 beams. Thus, the P1 beam management procedure may help to identify both a network node Tx beam and a UE Rx beam.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure May enable the network node 110 to select a best transmit beam based at least in part on measurements of the CSI-RSs (e.g., measured by the UE 120 using the single receive beam) reported by the UE 120.

In example 410, P2 beam management may involve network node beam refinement based on CSI-RS [BM]. During P2 beam management, the network node may sweep a refined beam set using CSI-RS [BM] resources (e.g., using a one- or two-port reference signal). The UE may measure the beam set using a beam from P1 beam management that is fixed. The P2 beam management may refine the network node beam based on a UE report (e.g., a P2 report).

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In example 420, P3 beam management may involve UE beam refinement based on CSI-RS [BM]. During P2 beam management, the network node may send repeated transmissions over the best P2 beam (e.g., the P2 beam that provides a highest-quality BPL) using a set of CSI-RS [BM] resources (e.g., using a one- or two-port reference signal). The P2 beam management may refine the UE beam.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

Current telecommunication standards do not rigidly define P1/P2/P3 beam management algorithms for the UE and the network node. For example, telecommunication standards do not constrain the ordering or quantity of P2 or P3 sessions for a given SSB measurement timing configuration (SMTC).

A typical P1/P2/P3 procedure is provided as follows. During P1 beam management, the network node broadcasts reference signals using a coarse beam codebook. The UE may then perform an autonomous beam scan and refinement to establish an initial BPL. During P2 beam management, the network node may offer a subset of a “refined” beam codebook corresponding to network node beams. The UE may measure the network node beams with a UE beam selected from the P1 procedure. Based on the UE report, the network node may select a best P2 network node beam (e.g., a P2 network node beam that offers a highest-quality BPL). During P3 beam management, the network node may transmit a reference signal over the selected P2 refined beam multiple times such that the UE may further refine the UE beam. A P3 session may follow a P2 session in a sequential fashion.

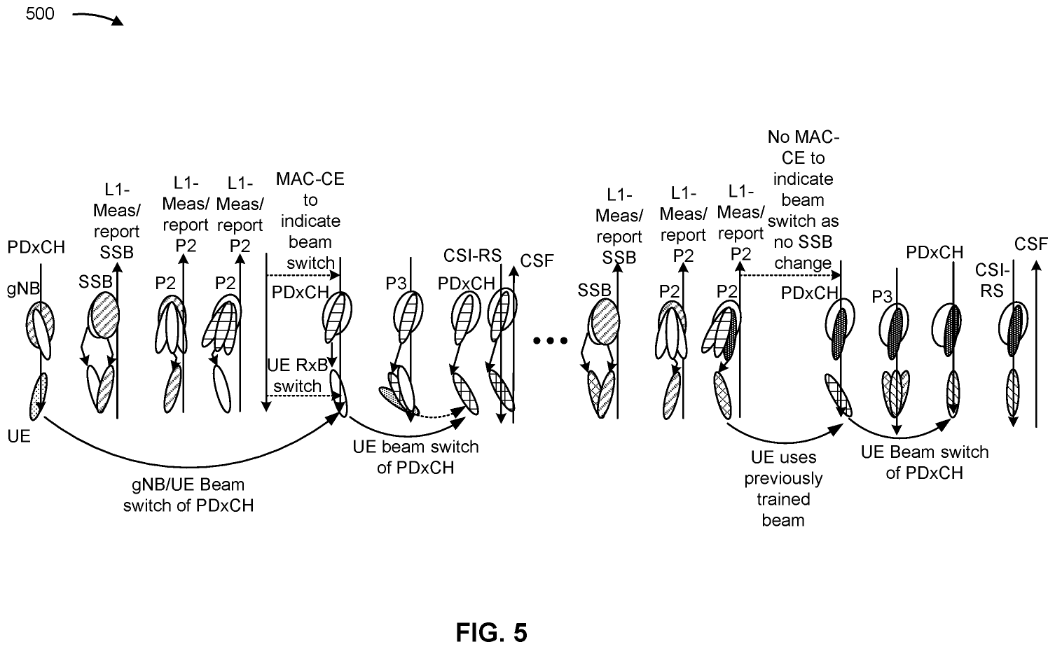

FIG. 5 is a diagram illustrating an example 500 of a timeline of beam management operations, in accordance with the present disclosure. As shown, an initial BPL enables the network node 110 to output, and the UE 120 to receive, PDxCH communications. As used herein, “PDxCH” may be any suitable physical downlink channel, such as a physical downlink control channel (PDCCH), a physical downlink shared channel (PDSCH), or the like. The network node 110 and the UE 120 may perform a beam selection procedure (e.g., a P1 procedure) that involves two network node beams (e.g., two wide beams) including the wide beam associated with the initial BPL. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures.

Based on the L1 measurement reports, the network node 110 may determine that the network node 110 is to switch from the network node narrow beam in the initial BPL to a different network node narrow beam, where the narrow beams are associated with different wide beams. For example, the network node 110 may change the P2 narrow beam for the PDxCH to a different SSB. The network node 110 may output a MAC-CE indicating that the network node 110 is to perform a beam switch. Based on the MAC-CE, the UE 120 may switch from the UE Rx beam of the initial BPL to a different UE Rx beam for the PDxCH.

As shown, the UE 120 switches UE beams based on training during the beam selection procedure. For example, the UE 120 may switch to a UE beam that is associated with a wide beam involved in the beam selection procedure, but not with the network node narrow beam that the network node 110 is switching to (e.g., the narrow beam may be trained based on the SSB, which is not optimal). After a subsequent P3 session, the UE 120 may perform another beam switching operation that allows the UE 120 to switch to a UE beam that offers a higher-quality BPL than the previous UE beam for the network node beam that the network node 110 is switching to. Thus, a P3 session following a PDxCH beam switch may result in a sub-optimal UE beam for the PDxCH after the network node beam switch. For example, from at least the time when the UE 120 switches to the UE beam based on the MAC-CE to the time when the subsequent P3 session is performed, the UE 120 may use a suboptimal UE narrow beam.

As further shown in FIG. 5, after the operations discussed above, the network node 110 and the UE 120 may perform a beam selection procedure (e.g., a P1 procedure) that involves two network node beams (e.g., two wide beams), including the wide beam associated with the current network node narrow beam. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures.

Based on the L1 measurement reports, the network node 110 may determine that the network node 110 is to switch from the current network node narrow beam to a different network node narrow beam, where the narrow beams are associated with the same wide beam. For example, the network node 110 may change the P2 narrow beam for the PDxCH within the same SSB. In this case, the network node 110 may not output a MAC-CE indicating that the network node 110 is to perform a beam switch. The network node 110 may not output the MAC-CE because, in some deployments, beam indication (e.g., the MAC-CE) is performed only for wide beams (e.g., for SSB) and not for narrow beams identified during the P2 session. Since there is a narrow beam change within a given SSB wide beam, the network node 110 provides no such signaling to the UE 120.

As a result, until a new P3 session occurs, the UE 120 may continue to use the UE beam that was previously trained during an earlier P3 session, which may create a mis-alignment (e.g., a short-term mismatch) between the network node narrow beam and the UE beam for the PDxCH. The UE 120 may use the UE beam that was previously trained during an earlier P3 session (e.g., instead of switching to a different UE beam) due to the lack of network node beam switch information. After a subsequent P3 session, the UE 120 may perform another beam switching operation that allows the UE 120 to switch to a UE beam that enables a higher-quality BPL. As a result, from at least the time when the network node 110 switches to the narrow beam to the time when the subsequent P3 session is performed, the UE 120 may use a suboptimal UE beam.

For both cases described above (the case where the narrow beam switches to a narrow beam associated with a different wide beam and the case where the narrow beam switches to a narrow beam associated with the same wide beam), the ordering of the P2 session, the P3 session, and the PDxCH beam switches can cause the UE 120 to use a suboptimal UE beam.

As indicated above, FIG. 5 is provided as an example. Other examples may differ from what is described with respect to FIG. 5.

FIG. 6 is a diagram illustrating an example 600 associated with beam switching based on a UE beam refinement procedure, in accordance with the present disclosure. As shown in FIG. 6, a network node 110 and a UE 120 may communicate with one another.

As shown by reference number 610, the network node 110 may output, and the UE 120 may receive, for a UE beam refinement procedure, a reference signal via a first network node beam. For example, the UE beam refinement procedure may be a P3 procedure and the reference signal may be a CSI-RS. The first network node beam may be a first narrow beam (e.g., one of a plurality of narrow beams measured during a prior network node beam refinement procedure).

As shown by reference number 620, the network node 110 may output, and the UE 120 may receive, based at least in part on (e.g., after) the UE beam refinement procedure, an indication of a switch to the first network node beam from a second network node beam. The second network node beam may be a second narrow beam (e.g., one of a plurality of narrow beams measured during a prior network node beam refinement procedure). In some examples, the indication may comprise a MAC-CE. For instance, the MAC-CE may include the indication.

Outputting or receiving the indication of the switch to the first network node beam from the second network node beam based at least in part on (e.g., after) the UE beam refinement procedure may enable the UE 120 to switch to an appropriate or higher-quality UE beam (e.g., a UE beam offering a high-quality BPL) that matches the network node beam. For instance, the UE 120 may identify the appropriate UE beam, based on the UE beam refinement procedure, before receiving the indication (e.g., the MAC-CE). The UE 120 may use the higher-quality UE beam starting at (or shortly after) the time when the network node 110 switches narrow beams based on the indication (e.g., the MAC-CE).

Thus, example 600 may enable control of a P2-P3 sequence of operations such that the UE 120 uses a high-quality UE beam when the network node 110 switches network node beams. For example, the operating sequence of the P2 session, P3 session, CSI-RS, and/or MAC-CE may be scheduled by the network node 110.

In some aspects, the UE 120 may further switch, based at least in part on the indication of the switch to the first network node beam from the second network node beam, to a first UE beam from a second UE beam. For example, the first UE beam may be a UE beam selected during the UE beam refinement procedure. The indication (e.g., the MAC-CE) may prompt the UE 120 to switch to the first UE beam, which may help to ensure that the UE 120 maintains a high-quality BPL with the network node 110 after the network node beam switch.

As indicated above, FIG. 6 is provided as an example. Other examples may differ from what is described with respect to FIG. 6.

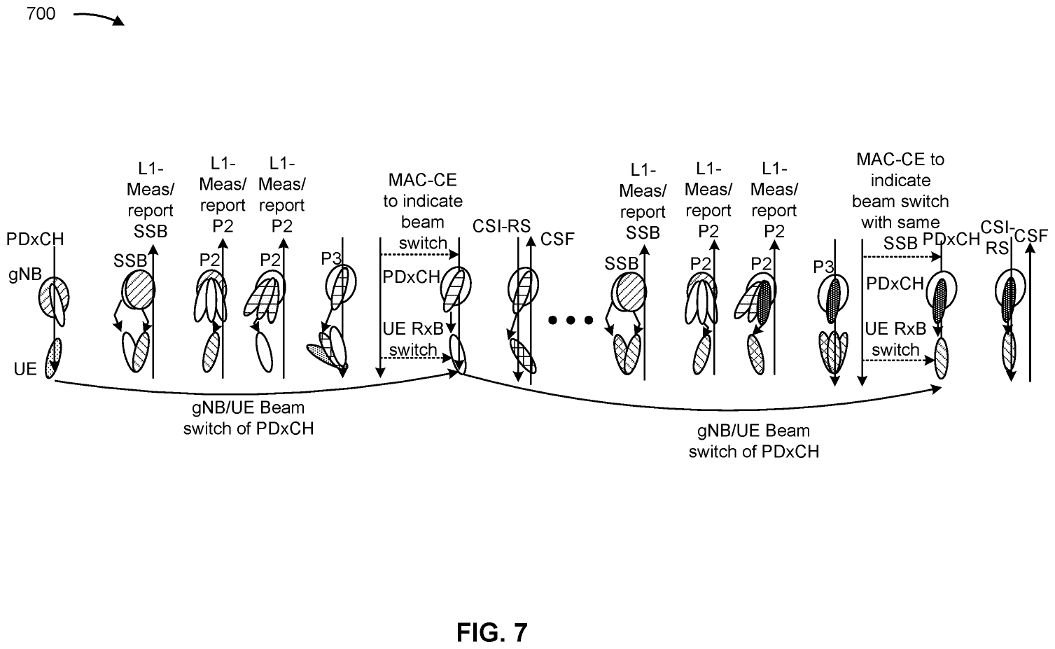

FIG. 7 is a diagram illustrating an example 700 of beam switching based on a UE beam refinement procedure for network node beams associated with the same or different network node beams associated with a beam selection procedure, in accordance with the present disclosure. As shown, an initial BPL enables the network node 110 to output, and the UE 120 to receive, PDxCH communications. The network node 110 and the UE 120 may perform a beam selection procedure (e.g., a P1 procedure) that involves two network node beams (e.g., two wide beams), including the wide beam associated with the initial BPL. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures. Based on the L1 measurement reports, the network node 110 may determine that the network node 110 is to switch from the network node narrow beam in the initial BPL to a different network node narrow beam.

The network node beam to which the network node 110 is switching may be associated with a network node beam associated with a beam selection procedure (e.g., a first wide beam measured during a P1 procedure), and the network node beam from which the network node 110 is switching may be associated with a different network node beam associated with the beam selection procedure (e.g., a second wide beam measured during the P1 procedure). For example, the network node beams involved in the network node beam switch may be associated with different wide beams.

As shown, the network node 110 may output, and the UE 120 may receive, for a UE beam refinement procedure (e.g., a P3 procedure), a reference signal (e.g., a CSI-RS) via the network node beam to which the network node 110 is switching. The network node 110 may output, and the UE 120 may receive, based at least in part on (e.g., after) the UE beam refinement procedure, an indication (e.g., a MAC-CE) of a switch to the network node beam. For example, after the P2 procedure, the network node 110 may send a P3 reference signal immediately (or a short time) before sending the MAC-CE indicating that the network node 110 is to switch the network node beam of the PDxCH.

In some examples, a transmission configuration indication (TCI) state of the UE beam refinement procedure may indicate a network node beam (e.g., a wide beam) associated with the network node beam that the network node 110 is switching to. The network node beam may be associated with a beam selection procedure (e.g., the wide beam may be measured during a prior P1 procedure). For example, the P3 TCI state may indicate an SSB transmitted over the wide beam that the narrow beam is selected based on. The TCI state indicating the network node beam associated with the network node beam that the network node 110 is switching to may enable the UE to carry out the UE beam refinement procedure using an appropriate set of UE beams.

Associating the network node beam to which the network node 110 is switching with a network node beam associated with the beam selection procedure, and associating the network node beam from which the network node 110 is switching with the different network node beam associated with the beam selection procedure may enable the UE 120 to use the appropriate UE beam when the network node beam switch involves different network node beams (e.g., different wide beams). For example, the UE 120 may determine the appropriate beam based on the UE beam refinement procedure before receiving the indication (e.g., the MAC-CE). Receiving the indication may prompt the UE 120 to switch to the network node beam associated with a different wide beam.

As further shown in FIG. 7, after the operations discussed above, the network node 110 and the UE 120 may perform a beam selection procedure (e.g., a P1 procedure) that involves two network node beams (e.g., two wide beams), including the wide beam associated with the current network node narrow beam. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures. Based on the L1 measurement reports, the network node 110 may determine that the network node 110 is to switch from the current network node narrow beam to a different network node narrow beam.

The network node beam to which the network node 110 is switching may be associated with a network node beam associated with a beam selection procedure (e.g., a first wide beam measured during a P1 procedure). For example, the network node beams involved in the network node beam switch may be associated with the same wide beam.

As shown, the network node 110 may output, and the UE 120 may receive, for a UE beam refinement procedure (e.g., a P3 procedure), a reference signal (e.g., a CSI-RS) via the network node beam to which the network node 110 is switching. The network node 110 may output, and the UE 120 may receive, based at least in part on (e.g., after) the UE beam refinement procedure, an indication (e.g., a MAC-CE) of a switch to the network node beam. For example, the MAC-CE may indicate the TCI of the PDxCH. For example, the MAC-CE may indicate a network node beam switch to a narrow beam associated with the same SSB as the current narrow beam, and the MAC-CE may be transmitted with the same TCI state for both narrow beams.

Associating the network node beam to which the network node 110 is switching and the network node beam from which the network node 110 is switching with a network node beam associated with the beam selection procedure may enable the UE 120 to use a higher-quality UE beam when the network node beam switch involves the same network node beam (e.g., the same wide beam). For example, in response to the indication (e.g., the MAC-CE), the UE 120 may switch to a higher-quality UE beam when (or shortly after) the time when the network node 110 switches narrow beams. The network node 110 may send, to the UE 120, the MAC-CE indicating that the network node 110 is to carry out a narrow beam switch for the PDxCH, even if the network node beam switch does not involve a wide beam (e.g., SSB) switch. For example, the MAC-CE may indicate the TCI of the PDxCH. The UE 120 may switch the UE Rx beam based on the P3 session at a MAC-CE action time (e.g., 3 ms).

In some examples, a P3 procedure may occur and the network node 110 may not perform a narrow beam switch, and as a result the network node 110 may not send a beam switch indication (e.g., a MAC-CE) to UE 120. The network node 110 may output, and the UE 120 may receive, for a UE beam refinement procedure (e.g., a P3 session), a reference signal via a network node beam. For example, the network node 110 may output, and the UE 120 may receive, for a P3 procedure, a CSI-RS via a network node narrow beam.

In some examples, the UE 120 may switch, based at least in part on a timer, from a first UE beam to a second UE beam. For example, the timer may begin after the P3 session. The UE 120 may use the timer to determine when to switch a UE Rx beam after the P3 session in the event that the UE 120 does not receive a MAC-CE. The length of the timer may be based on the expected time window for the UE 120 to receive a MAC-CE. Thus, when there is no network node narrow beam switch, the network node 110 may refrain from sending a MAC-CE, and the UE 120 may use a timer to determine when to switch the UE Rx beam after the P3 session. Switching from a first UE beam to a second UE beam based at least in part on the timer may enable the UE 120 to perform UE beam switching in the case where the network node 110 does not send a MAC-CE (e.g., in a case where the network node does not perform network node beam switching).

As indicated above, FIG. 7 is provided as an example. Other examples may differ from what is described with respect to FIG. 7.

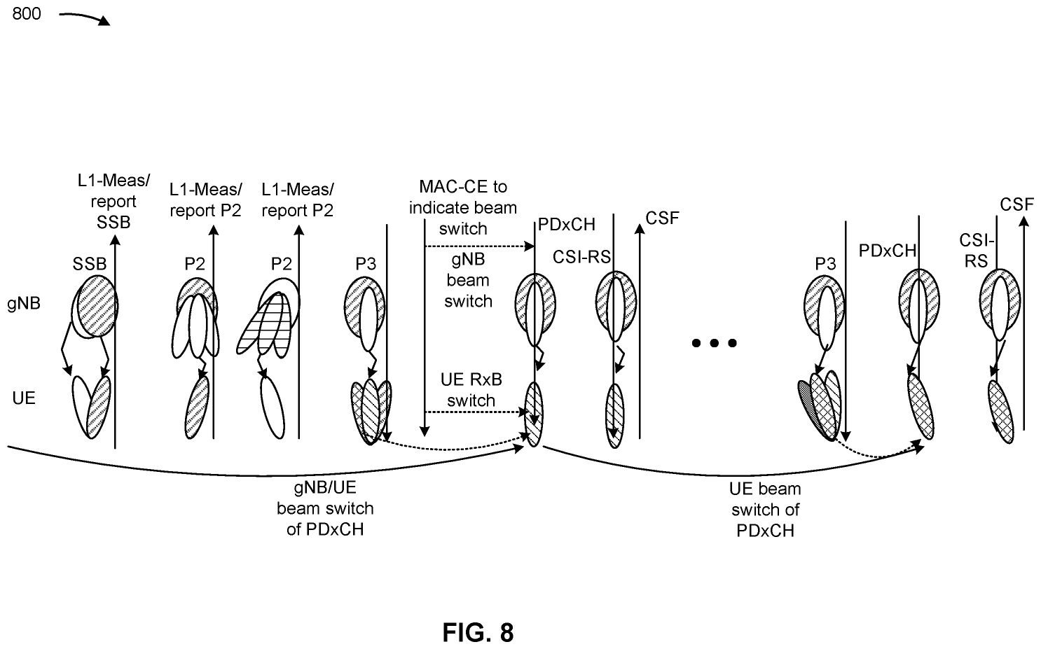

FIG. 8 is a diagram illustrating an example 800 of autonomous UE beam switching, in accordance with the present disclosure. As shown, an initial BPL enables the network node 110 to output, and the UE 120 to receive, PDxCH communications. The network node 110 and the UE 120 may perform a beam selection procedure (e.g., a P1 procedure) that involves two network node beams (e.g., two wide beams), including the wide beam associated with the initial BPL. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures. Based on the L1 measurement reports, the network node 110 may determine that the network node 110 is to switch from the network node narrow beam in the initial BPL to a different network node narrow beam.

As shown, the network node 110 may output, and the UE 120 may receive, for a UE beam refinement procedure (e.g., a P3 procedure), a reference signal (e.g., a CSI-RS) via the network node beam to which the network node 110 is switching. The network node 110 may output, and the UE 120 may receive, based at least in part on (e.g., after) the UE beam refinement procedure, an indication (e.g., a MAC-CE) of a switch to the network node beam. Based on the UE beam refinement procedure and/or the indication of the switch to the network node beam, the UE 120 may perform UE beam switching operations as discussed elsewhere herein.

In some examples (e.g., after the UE 120 performs the UE beam switching operations), the network node 110 may output, and the UE 120 may receive, for another UE beam refinement procedure (e.g., a P3 procedure), another reference signal (e.g., a CSI-RS) via the network node beam to which the network node 110 switched. For example, the network node 110 and the UE 120 may participate in multiple P3 sessions after the P2 session before the beam switch.

Based at least in part on the other UE beam refinement procedure (e.g., the P3 procedure), the UE 120 may autonomously switch from a first UE beam to a second UE beam. For example, the UE 120 may perform the UE beam switch without a corresponding network node beam switch. In some examples, after each P3 session that occurs after the P2 session, the UE 120 may perform an autonomous switching operation. For instance, each P3 session may involve the same network node narrow beam determined by the network node in the latest P2 session based on a UE report. Autonomously switching to the second UE beam may enable the UE 120 to perform a UE beam switch when the network node 110 is not performing a corresponding network node beam switch.

As indicated above, FIG. 8 is provided as an example. Other examples may differ from what is described with respect to FIG. 8.

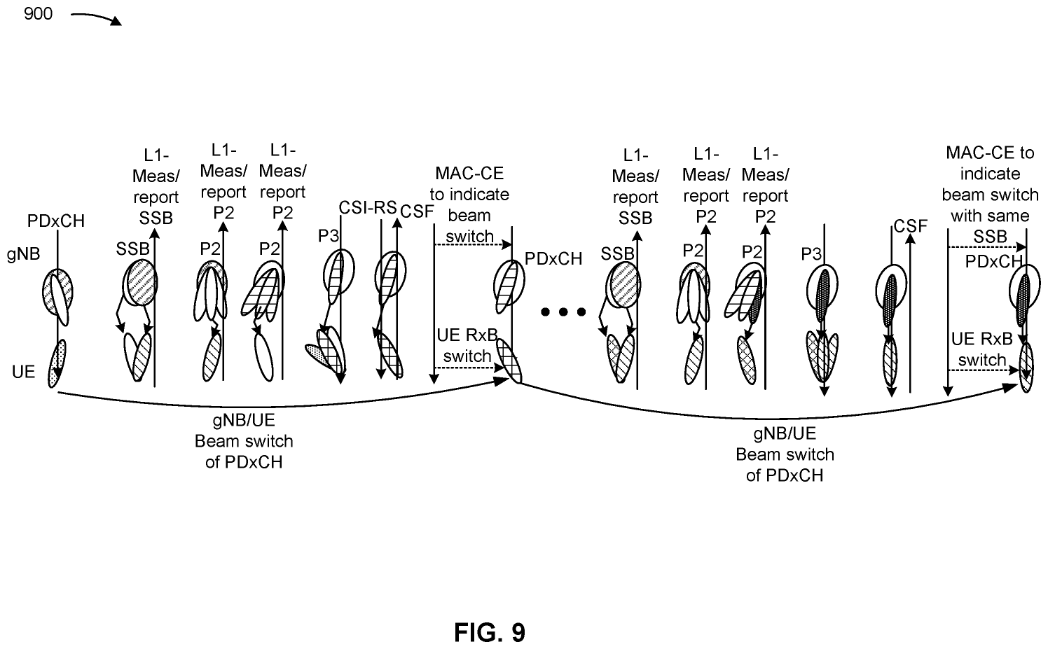

FIG. 9 is a diagram illustrating an example 900 of channel state feedback (CSF) updating, in accordance with the present disclosure. As shown, an initial BPL enables the network node 110 to output, and the UE 120 to receive, PDxCH communications. The network node 110 and the UE 120 may perform a beam selection procedure (e.g., a P1 procedure) that involves two network node beams (e.g., two wide beams), including the wide beam associated with the initial BPL. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures. Based on the L1 measurement reports, the network node 110 may determine that the network node 110 is to switch from the network node narrow beam in the initial BPL to a different network node narrow beam. The network node narrow beams may be associated with different wide beams.

As shown, the network node 110 may output, and the UE 120 may receive, for a UE beam refinement procedure (e.g., a P3 procedure), a reference signal (e.g., a CSI-RS) via the network node beam to which the network node 110 is switching. The network node 110 may output, and the UE 120 may receive, a CSI-RS based at least in part on (e.g., after) the UE beam refinement procedure. For example, the network node 110 may send the CSI-RS for a channel quality indicator (CQI) (e.g., for channel state feedback (CSF)) before the beam switching for the PDxCH occurs. As shown, the UE 120 may provide a CSF report based on the CSI-RS. The network node 110 may output, and the UE 120 may receive, based at least in part on (e.g., after) the UE beam refinement procedure and the CSI-RS, an indication (e.g., a MAC-CE) of a switch to the network node beam. In some examples, an additional delay (e.g., 3 ms) may be introduced between the P3 session and the transmission of the CSI-RS to allow for a UE turn-around time. Outputting and receiving the CSI-RS may enable up-to-date CSF to be provided when the beam switch occurs (by contrast, in the example of FIG. 5, the CSF is not updated when the beam switch occurs, regardless of whether the network node beam that the network node 110 is switching to and the current network node beam are associated with different wide beams).

As further shown in FIG. 9, after the operations discussed above, the network node 110 and the UE 120 may perform a beam selection procedure (e.g., a P1 procedure) that involves two network node beams (e.g., two wide beams), including the wide beam associated with the current network node narrow beam. The UE 120 may transmit an L1 measurement report based on the beam selection procedure. After the beam selection procedure, the network node 110 and the UE 120 may perform, for each wide beam, a network node beam refinement procedure (e.g., a P2 procedure) for a subset of network node beams (e.g., narrow beams) associated with that wide beam. The UE 120 may transmit an L1 measurement report based on both beam selection procedures. Based on the L1 measurement reports, the network node 110 may determine that the network node 110 is to switch from the current network node narrow beam to a different network node narrow beam. The network node narrow beams may be associated with the same wide beam.

As shown, the network node 110 may output, and the UE 120 may receive, for a UE beam refinement procedure (e.g., a P3 procedure), a reference signal (e.g., a CSI-RS) via the network node beam to which the network node 110 is switching. The network node 110 may output, and the UE 120 may receive, a CSI-RS based at least in part on (e.g., after) the UE beam refinement procedure. For example, the network node 110 may send the CSI-RS for a CQI (e.g., for CSF) before the beam switching for the PDxCH occurs. As shown, the UE 120 may provide a CSF report based on the CSI-RS. The network node 110 may output, and the UE 120 may receive, based at least in part on (e.g., after) the UE beam refinement procedure and the CSI-RS, an indication (e.g., a MAC-CE) of a switch to the network node beam. In some examples, an additional delay (e.g., 3 ms) may be introduced between the P3 session and the transmission of the CSI-RS to allow for a UE 120 turn-around time. Outputting and receiving the CSI-RS may enable up-to-date CSF to be provided when the beam switch occurs (by contrast, in the example of FIG. 5, the CSF is not updated when the beam switch occurs, regardless of whether the network node beam that the network node 110 is switching to shares a wide beam with the current network node beam).

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with beam switching based on a UE beam refinement procedure.

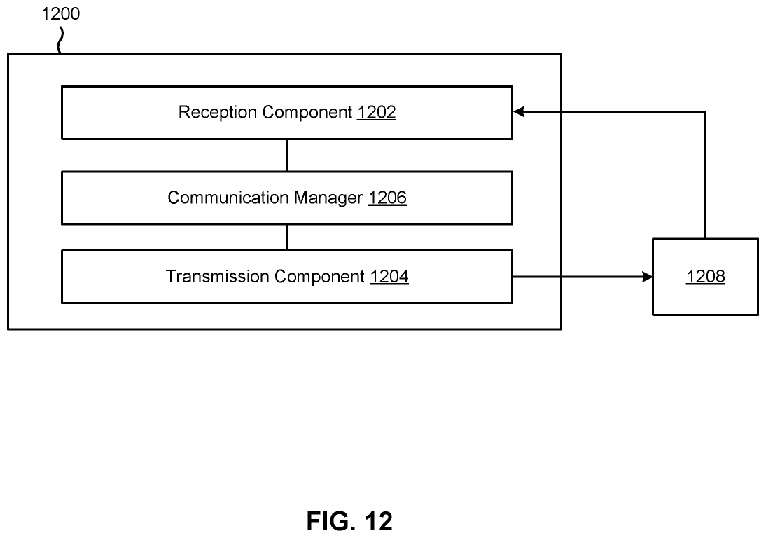

As shown in FIG. 10, in some aspects, process 1000 may include receiving, for a UE beam refinement procedure, a reference signal via a first network node beam (block 1010). For example, the UE (e.g., using communication manager 140 and/or reception component 1202, depicted in FIG. 12) may receive, for a UE beam refinement procedure, a reference signal via a first network node beam, as described above, for example, with reference to FIGS. 6, 7, 8, and/or 9.

As further shown in FIG. 10, in some aspects, process 1000 may include receiving, based at least in part on the UE beam refinement procedure, an indication of a switch to the first network node beam from a second network node beam (block 1020). For example, the UE (e.g., using communication manager 140 and/or reception component 1202, depicted in FIG. 12) may receive, based at least in part on the UE beam refinement procedure, an indication of a switch to the first network node beam from a second network node beam, as described above, for example, with reference to FIGS. 6, 7, 8, and/or 9.

Process 1000 may include additional aspects, such as any single aspect or any combination of aspects described below and/or in connection with one or more other processes described elsewhere herein.

In a first aspect, the first network node beam is associated with a third network node beam associated with a beam selection procedure and the second network node beam is associated with a fourth network node beam associated with the beam selection procedure.

In a second aspect, the first network node beam and the second network node beam are associated with a third network node beam associated with a beam selection procedure.

In a third aspect, alone or in combination with one or more of the first and second aspects, process 1000 includes switching, based at least in part on the indication of the switch to the first network node beam from the second network node beam, to a first UE beam from a second UE beam.

In a fourth aspect, alone or in combination with one or more of the first through third aspects, a TCI state of the UE beam refinement procedure indicates a third network node beam associated with the first network node beam, and the third network node beam is associated with a beam selection procedure.

In a fifth aspect, alone or in combination with one or more of the first through fourth aspects, the UE beam refinement procedure is a first UE beam refinement procedure, the reference signal is a first reference signal, and process 1000 includes receiving, for a second UE beam refinement procedure, a second reference signal via a third network node beam, and switching, based at least in part on a timer, from a first UE beam to a second UE beam.

In a sixth aspect, alone or in combination with one or more of the first through fifth aspects, the UE beam refinement procedure is a first UE beam refinement procedure, the reference signal is a first reference signal, and process 1000 includes receiving, for a second UE beam refinement procedure, a second reference signal via the first network node beam, and switching, based at least in part on the UE beam refinement procedure, autonomously from a first UE beam to a second UE beam.

In a seventh aspect, alone or in combination with one or more of the first through sixth aspects, process 1000 includes receiving, based at least in part on the UE beam refinement procedure, a CSI-RS, and transmitting, based at least in part on the CSI-RS, a CSF report, and receiving the indication of the switch to the first network node beam from the second network node beam includes receiving the indication of the switch to the first network node beam from the second network node beam based at least in part on the CSF report.

In an eighth aspect, alone or in combination with one or more of the first through seventh aspects, the indication of the switch to the first network node beam from the second network node beam comprises a MAC-CE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with beam switching based on a UE beam refinement procedure.

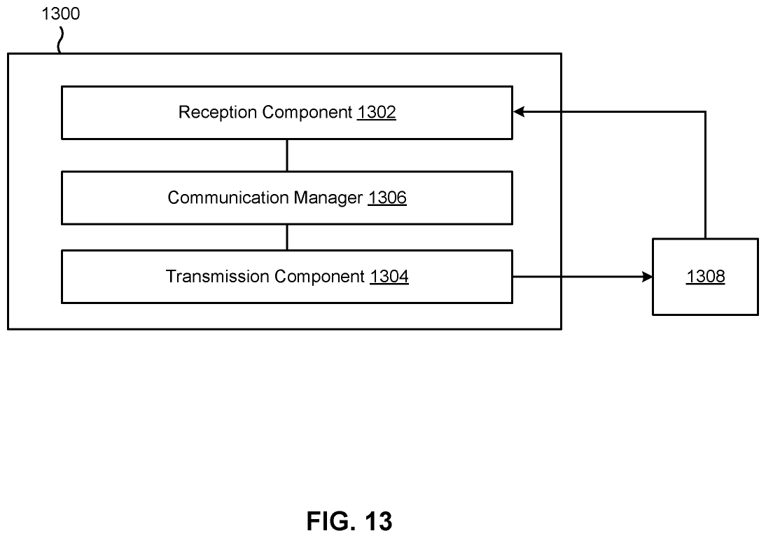

As shown in FIG. 11, in some aspects, process 1100 may include outputting, for a UE beam refinement procedure, a reference signal via a first network node beam (block 1110). For example, the network node (e.g., using communication manager 150 and/or transmission component 1304, depicted in FIG. 13) may output, for a UE beam refinement procedure, a reference signal via a first network node beam, as described above, for example, with reference to FIGS. 6, 7, 8, and/or 9.

As further shown in FIG. 11, in some aspects, process 1100 may include outputting, based at least in part on the UE beam refinement procedure, an indication of a switch to the first network node beam from a second network node beam (block 1120). For example, the network node (e.g., using communication manager 150 and/or transmission component 1304, depicted in FIG. 13) may output, based at least in part on the UE beam refinement procedure, an indication of a switch to the first network node beam from a second network node beam, as described above, for example, with reference to FIGS. 6, 7, 8, and/or 9.

Process 1100 may include additional aspects, such as any single aspect or any combination of aspects described below and/or in connection with one or more other processes described elsewhere herein.

In a first aspect, the first network node beam is associated with a third network node beam associated with a beam selection procedure and the second network node beam is associated with a fourth network node beam associated with the beam selection procedure.

In a second aspect, the first network node beam and the second network node beam are associated with a third network node beam associated with a beam selection procedure.

In a third aspect, alone or in combination with one or more of the first and second aspects, a UE switches, based at least in part on the indication of the switch to the first network node beam from the second network node beam, to a first UE beam from a second UE beam.

In a fourth aspect, alone or in combination with one or more of the first through third aspects, a TCI state of the UE beam refinement procedure indicates a third network node beam associated with the first network node beam, and the third network node beam is associated with a beam selection procedure.

In a fifth aspect, alone or in combination with one or more of the first through fourth aspects, the UE beam refinement procedure is a first UE beam refinement procedure, the reference signal is a first reference signal, process 1100 includes outputting, for a second UE beam refinement procedure, a second reference signal via a third network node beam, and a UE switches, based at least in part on a timer, from a first UE beam to a second UE beam.

In a sixth aspect, alone or in combination with one or more of the first through fifth aspects, the UE beam refinement procedure is a first UE beam refinement procedure, the reference signal is a first reference signal, process 1100 includes outputting, for a second UE beam refinement procedure, a second reference signal via the first network node beam, and a UE switches, based at least in part on the UE beam refinement procedure, autonomously from a first UE beam to a second UE beam.

In a seventh aspect, alone or in combination with one or more of the first through sixth aspects, process 1100 includes outputting, based at least in part on the UE beam refinement procedure, a CSI-RS, and obtaining, based at least in part on the CSI-RS, a CSF report, wherein outputting the indication of the switch to the first network node beam from the second network node beam includes outputting the indication of the switch to the first network node beam from the second network node beam based at least in part on the CSF report.

In an eighth aspect, alone or in combination with one or more of the first through seventh aspects, the indication of the switch to the first network node beam from the second network node beam comprises a MAC-CE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, for a UE beam refinement procedure, a reference signal via a first network node beam. The reception component 1202 may receive, based at least in part on the UE beam refinement procedure, an indication of a switch to the first network node beam from a second network node beam.

The communication manager 1206 may switch, based at least in part on the indication of the switch to the first network node beam from the second network node beam, to a first UE beam from a second UE beam.

The reception component 1202 may receive, based at least in part on the UE beam refinement procedure, a CSI-RS.

The transmission component 1204 may transmit, based at least in part on the CSI-RS, a CSF report.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may output, for a UE beam refinement procedure, a reference signal via a first network node beam. The transmission component 1304 may output, based at least in part on the UE beam refinement procedure, an indication of a switch to the first network node beam from a second network node beam.

The transmission component 1304 may output, based at least in part on the UE beam refinement procedure, a CSI-RS.

The reception component 1302 may obtain, based at least in part on the CSI-RS, a CSF report, wherein outputting the indication of the switch to the first network node beam from the second network node beam includes outputting the indication of the switch to the first network node beam from the second network node beam based at least in part on the CSF report.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving, for a UE beam refinement procedure, a reference signal via a first network node beam; and receiving, based at least in part on the UE beam refinement procedure, an indication of a switch to the first network node beam from a second network node beam.

Aspect 2: The method of Aspect 1, wherein the first network node beam is associated with a third network node beam associated with a beam selection procedure and the second network node beam is associated with a fourth network node beam associated with the beam selection procedure.

Aspect 3: The method of Aspect 1, wherein the first network node beam and the second network node beam are associated with a third network node beam associated with a beam selection procedure.

Aspect 4: The method of any of Aspects 1-3, further comprising: switching, based at least in part on the indication of the switch to the first network node beam from the second network node beam, to a first UE beam from a second UE beam.

Aspect 5: The method of any of Aspects 1-4, wherein a TCI state of the UE beam refinement procedure indicates a third network node beam associated with the first network node beam, wherein the third network node beam is associated with a beam selection procedure.

Aspect 6: The method of any of Aspects 1-5, wherein the UE beam refinement procedure is a first UE beam refinement procedure, and wherein the reference signal is a first reference signal, the method further comprising: receiving, for a second UE beam refinement procedure, a second reference signal via a third network node beam; and switching, based at least in part on a timer, from a first UE beam to a second UE beam.

Aspect 7: The method of any of Aspects 1-6, wherein the UE beam refinement procedure is a first UE beam refinement procedure, and wherein the reference signal is a first reference signal, the method further comprising: receiving, for a second UE beam refinement procedure, a second reference signal via the first network node beam; and switching, based at least in part on the UE beam refinement procedure, autonomously from a first UE beam to a second UE beam.

Aspect 8: The method of any of Aspects 1-7, further comprising: receiving, based at least in part on the UE beam refinement procedure, a CSI-RS; and transmitting, based at least in part on the CSI-RS, a CSF report, wherein receiving the indication of the switch to the first network node beam from the second network node beam includes: receiving the indication of the switch to the first network node beam from the second network node beam based at least in part on the CSF report.

Aspect 9: The method of any of Aspects 1-8, wherein the indication of the switch to the first network node beam from the second network node beam comprises a MAC-CE.

Aspect 10: A method of wireless communication performed by a network node, comprising: outputting, for a UE beam refinement procedure, a reference signal via a first network node beam; and outputting, based at least in part on the UE beam refinement procedure, an indication of a switch to the first network node beam from a second network node beam.

Aspect 11: The method of Aspect 10, wherein the first network node beam is associated with a third network node beam associated with a beam selection procedure and the second network node beam is associated with a fourth network node beam associated with the beam selection procedure.

Aspect 12: The method of Aspect 10 wherein the first network node beam and the second network node beam are associated with a third network node beam associated with a beam selection procedure.

Aspect 13: The method of any of Aspects 10-12, wherein a UE switches, based at least in part on the indication of the switch to the first network node beam from the second network node beam, to a first UE beam from a second UE beam.

Aspect 14: The method of any of Aspects 10-13, wherein a TCI state of the UE beam refinement procedure indicates a third network node beam associated with the first network node beam, wherein the third network node beam is associated with a beam selection procedure.

Aspect 15: The method of any of Aspects 10-14, wherein the UE beam refinement procedure is a first UE beam refinement procedure, and wherein the reference signal is a first reference signal, the method further comprising: outputting, for a second UE beam refinement procedure, a second reference signal via a third network node beam, wherein a UE switches, based at least in part on a timer, from a first UE beam to a second UE beam.

Aspect 16: The method of any of Aspects 10-15, wherein the UE beam refinement procedure is a first UE beam refinement procedure, and wherein the reference signal is a first reference signal, the method further comprising: outputting, for a second UE beam refinement procedure, a second reference signal via the first network node beam, wherein a UE switches, based at least in part on the UE beam refinement procedure, autonomously from a first UE beam to a second UE beam.

Aspect 17: The method of any of Aspects 10-16, further comprising: outputting, based at least in part on the UE beam refinement procedure, a CSI-RS; and obtaining, based at least in part on the CSI-RS, a CSF report, wherein outputting the indication of the switch to the first network node beam from the second network node beam includes: outputting the indication of the switch to the first network node beam from the second network node beam based at least in part on the CSF report.

Aspect 18: The method of any of Aspects 10-17, wherein the indication of the switch to the first network node beam from the second network node beam comprises a MAC-CE.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors, individually or in any combination, configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, which are, individually or in any combination, configured to:
receive, for a UE beam refinement procedure, a reference signal via a first network node beam; and
receive, based at least in part on the UE beam refinement procedure, an indication of a switch to the first network node beam from a second network node beam.

2. The UE of claim 1, wherein the first network node beam is associated with a third network node beam associated with a beam selection procedure and the second network node beam is associated with a fourth network node beam associated with the beam selection procedure.

3. The UE of claim 1, wherein the first network node beam and the second network node beam are associated with a third network node beam associated with a beam selection procedure.

4. The UE of claim 1, wherein the one or more processors are, individually or in any combination, further configured to:
switch, based at least in part on the indication of the switch to the first network node beam from the second network node beam, to a first UE beam from a second UE beam.

5. The UE of claim 1, wherein a transmission configuration indication (TCI) state of the UE beam refinement procedure indicates a third network node beam associated with the first network node beam, wherein the third network node beam is associated with a beam selection procedure.

6. The UE of claim 1, wherein the UE beam refinement procedure is a first UE beam refinement procedure, and wherein the reference signal is a first reference signal, and wherein the one or more processors are, individually or in any combination, further configured to:
receive, for a second UE beam refinement procedure, a second reference signal via a third network node beam; and
switch, based at least in part on a timer, from a first UE beam to a second UE beam.

7. The UE of claim 1, wherein the UE beam refinement procedure is a first UE beam refinement procedure, and wherein the reference signal is a first reference signal, and wherein the one or more processors are, individually or in any combination, further configured to:
receive, for a second UE beam refinement procedure, a second reference signal via the first network node beam; and
switch, based at least in part on the UE beam refinement procedure, autonomously from a first UE beam to a second UE beam.

8. The UE of claim 1, wherein the one or more processors are, individually or in any combination, further configured to:
receive, based at least in part on the UE beam refinement procedure, a channel state information reference signal (CSI-RS); and
transmit, based at least in part on the CSI-RS, a channel state feedback (CSF) report, and
wherein the one or more processors, to receive the indication of the switch to the first network node beam from the second network node beam, are, individually or in any combination, configured to:
receive the indication of the switch to the first network node beam from the second network node beam based at least in part on the CSF report.

9. The UE of claim 1, wherein the indication of the switch to the first network node beam from the second network node beam comprises a media access control (MAC) control element (MAC-CE).

10. A network node for wireless communication, comprising:
one or more memories; and
one or more processors, coupled to the one or more memories, which are, individually or in any combination, configured to:
output, for a user equipment (UE) beam refinement procedure, a reference signal via a first network node beam; and
output, based at least in part on the UE beam refinement procedure, an indication of a switch to the first network node beam from a second network node beam.

11. The network node of claim 10, wherein the first network node beam is associated with a third network node beam associated with a beam selection procedure and the second network node beam is associated with a fourth network node beam associated with the beam selection procedure.

12. The network node of claim 10, wherein the first network node beam and the second network node beam are associated with a third network node beam associated with a beam selection procedure.

13. The network node of claim 10, wherein a UE switches, based at least in part on the indication of the switch to the first network node beam from the second network node beam, to a first UE beam from a second UE beam.

14. The network node of claim 10, wherein a transmission configuration indication (TCI) state of the UE beam refinement procedure indicates a third network node beam associated with the first network node beam, wherein the third network node beam is associated with a beam selection procedure.

15. The network node of claim 10, wherein the UE beam refinement procedure is a first UE beam refinement procedure, and wherein the reference signal is a first reference signal, and wherein the one or more processors are, individually or in any combination, further configured to:
output, for a second UE beam refinement procedure, a second reference signal via a third network node beam, wherein a UE switches, based at least in part on a timer, from a first UE beam to a second UE beam.

16. The network node of claim 10, wherein the UE beam refinement procedure is a first UE beam refinement procedure, and wherein the reference signal is a first reference signal, and wherein the one or more processors are, individually or in any combination, further configured to:
output, for a second UE beam refinement procedure, a second reference signal via the first network node beam, wherein a UE switches, based at least in part on the UE beam refinement procedure, autonomously from a first UE beam to a second UE beam.

17. The network node of claim 10, wherein the one or more processors are, individually or in any combination, further configured to:
output, based at least in part on the UE beam refinement procedure, a channel state information reference signal (CSI-RS); and
obtain, based at least in part on the CSI-RS, a channel state feedback (CSF) report, and
wherein the one or more processors, to output the indication of the switch to the first network node beam from the second network node beam, are, individually or in any combination, configured to:
output the indication of the switch to the first network node beam from the second network node beam based at least in part on the CSF report.

18. The network node of claim 10, wherein the indication of the switch to the first network node beam from the second network node beam comprises a media access control (MAC) control element (MAC-CE).

19. A method of wireless communication performed by a user equipment (UE), comprising:
receiving, for a UE beam refinement procedure, a reference signal via a first network node beam; and
receiving, based at least in part on the UE beam refinement procedure, an indication of a switch to the first network node beam from a second network node beam.

20. The method of claim 19, wherein the first network node beam is associated with a third network node beam associated with a beam selection procedure and the second network node beam is associated with a fourth network node beam associated with the beam selection procedure.

21. The method of claim 19, wherein the first network node beam and the second network node beam are associated with a third network node beam associated with a beam selection procedure.

22. The method of claim 19, wherein a transmission configuration indication (TCI) state of the UE beam refinement procedure indicates a third network node beam associated with the first network node beam, wherein the third network node beam is associated with a beam selection procedure.

23. The method of claim 19, wherein the UE beam refinement procedure is a first UE beam refinement procedure, and wherein the reference signal is a first reference signal, the method further comprising:
receiving, for a second UE beam refinement procedure, a second reference signal via a third network node beam; and
switching, based at least in part on a timer, from a first UE beam to a second UE beam.

24. The method of claim 19, wherein the UE beam refinement procedure is a first UE beam refinement procedure, and wherein the reference signal is a first reference signal, the method further comprising:
receiving, for a second UE beam refinement procedure, a second reference signal via the first network node beam; and
switching, based at least in part on the UE beam refinement procedure, autonomously from a first UE beam to a second UE beam.

25. A method of wireless communication performed by a network node, comprising:
outputting, for a user equipment (UE) beam refinement procedure, a reference signal via a first network node beam; and
outputting, based at least in part on the UE beam refinement procedure, an indication of a switch to the first network node beam from a second network node beam.

26. The method of claim 25, wherein the first network node beam is associated with a third network node beam associated with a beam selection procedure and the second network node beam is associated with a fourth network node beam associated with the beam selection procedure.

27. The method of claim 25, wherein the first network node beam and the second network node beam are associated with a third network node beam associated with a beam selection procedure.

28. The method of claim 25, wherein a transmission configuration indication (TCI) state of the UE beam refinement procedure indicates a third network node beam associated with the first network node beam, wherein the third network node beam is associated with a beam selection procedure.

29. The method of claim 25, wherein the UE beam refinement procedure is a first UE beam refinement procedure, and wherein the reference signal is a first reference signal, the method further comprising:
outputting, for a second UE beam refinement procedure, a second reference signal via a third network node beam, wherein a UE switches, based at least in part on a timer, from a first UE beam to a second UE beam.

30. The method of claim 25, wherein the UE beam refinement procedure is a first UE beam refinement procedure, and wherein the reference signal is a first reference signal, the method further comprising:
outputting, for a second UE beam refinement procedure, a second reference signal via the first network node beam, wherein a UE switches, based at least in part on the UE beam refinement procedure, autonomously from a first UE beam to a second UE beam.
